(19) United States
(12) Patent Application Publication
(10) Pub. No.: US 2024/0272290 A1
(43) Pub. Date: Aug. 15, 2024

(54) COMMUNICATION DEVICE, WIRELESS DISTANCE MEASURING SYSTEM, CONTROL CIRCUIT, STORAGE MEDIUM, AND ANOMALY DETECTION METHOD

(71) Applicant: Mitsubishi Electric Corporation, Tokyo (JP)

(72) Inventors: Akira KURITA, Tokyo (JP); Shusaku UMEDA, Tokyo (JP); Akinori TAIRA, Tokyo (JP); Hiroyasu SANO, Tokyo (JP)

(73) Assignee: Mitsubishi Electric Corporation, Tokyo (JP)

(21) Appl. No.: 18/645,510

(22) Filed: Apr. 25, 2024

Related U.S. Application Data
(63) Continuation of application No. PCT/JP2021/047624, filed on Dec. 22, 2021.

(51) Int. Cl. G01S 11/02; H04W 24/10; H04W 64/00

(52) U.S. Cl. CPC G01S 11/02; H04W 24/10; H04W 64/006

(57) ABSTRACT

A mobile device which is a communication device that wirelessly communicates with a fixed device fixed on a ground includes: a distance calculation unit that calculates a distance between the fixed device and the communication device based on a reception signal from the fixed device; a comparison target information acquisition unit that acquires comparison target information that is information indicating a distance between the fixed device and the communication device or an absolute position of the communication device, the information being based on a scheduled position of the communication device; and an anomaly detection unit that detects an anomaly occurring in the position of the fixed device based on whether the distance calculated by the distance calculation unit matches the comparison target information.

### CROSS-REFERENCE TO RELATED APPLICATION

This application is a continuation application of International Application PCT/JP2021/047624, filed on Dec. 22, 2021, and designating the U.S., the entire contents of which are incorporated herein by reference.

### BACKGROUND OF THE INVENTION

### 1. Field of the Invention

The present disclosure relates to a communication device that measures a distance using a wireless signal, a wireless distance measuring system, a control circuit, a storage medium, and an anomaly detection method.

### 2. Description of the Related Art

A technique of measuring the distance between devices from the timing of transmitting and receiving a wireless signal is used. A mobile device measures the distances to three or more fixed devices positions of which are known in advance, whereby the position of the mobile device can be estimated.

Position detection systems that estimate the position of mobile devices may be used in various fields such as railway and automobile. However, if a malicious person moves a fixed device from the position where the fixed device is supposed to exist or steals a fixed device, the position of mobile devices cannot be correctly estimated, and the safety of the system may be greatly impaired.

Japanese Patent No. 6871816 discloses a carry-out detection device that continues calculating the distance between the position of a terminal device acquired by a global positioning system (GPS) and the track on which the terminal device is scheduled to exist, and determines that the terminal device has been illegally carried out from the track on which the terminal device is supposed to exist if the calculated distance exceeds a predetermined threshold, thereby detecting the terminal device being illegally carried out. The carry-out detection device is a device prepared separately from the terminal device.

However, the above-described conventional technique is problematic in that it is not possible to detect an anomaly occurring in the position of the terminal device such as illegally carrying out the terminal device in a place where GPS positioning cannot be performed.

The present disclosure has been made in view of the above, and an object thereof is to provide a communication device capable of detecting an anomaly occurring in the position of the device even in a place where GPS positioning cannot be performed.

### SUMMARY OF THE INVENTION

To solve the problem and achieve the object described above, a communication device according to the present disclosure is a communication device that wirelessly communicates with a fixed device fixed on a ground and comprises: a distance calculation unit to calculate a distance between the fixed device and the communication device based on a reception signal from the fixed device; a comparison target information acquisition unit to acquire comparison target information that is information indicating a distance between the fixed device and the communication device or an absolute position of the communication device, the information being based on a scheduled position of the communication device; and an anomaly detection unit to detect an anomaly occurring in the position of the fixed device based on whether the distance calculated by the distance calculation unit matches the comparison target information.

### BRIEF DESCRIPTION OF THE DRAWINGS

FIG. 1 is a diagram schematically illustrating a wireless distance measuring system according to the first embodiment;

FIG. 2 is a diagram for schematically explaining a method of estimating the position of the mobile device in the wireless distance measuring system illustrated in FIG. 1;

FIG. 3 is a diagram for explaining a specific method of estimating the position of the mobile device in the wireless distance measuring system illustrated in FIG. 1;

FIG. 4 is a diagram illustrating a functional configuration of the fixed device according to the first embodiment;

FIG. 5 is a diagram illustrating a functional configuration of the mobile device according to the first embodiment;

FIG. 6 is a diagram illustrating an example of the distance information database illustrated in FIG. 5;

FIG. 7 is a diagram illustrating an example of a temporal change in the positional relationship between the fixed device and the mobile device;

FIG. 8 is a diagram schematically illustrating an absolute position database indicating the absolute position of the fixed device according to the first embodiment;

FIG. 9 is a flowchart for explaining the operation of the wireless distance measuring system according to the first embodiment;

FIG. 10 is a diagram illustrating a functional configuration of the mobile device according to the second embodiment;

FIG. 11 is a flowchart for explaining the operation of the wireless distance measuring system according to the second embodiment;

FIG. 12 is a diagram illustrating an exemplary configuration of a wireless distance measuring system according to the fourth embodiment;

FIG. 13 is a diagram illustrating a functional configuration of the fixed device according to the fourth embodiment;

FIG. 14 is a diagram illustrating an example of the inter-fixed-device distance information database illustrated in FIG. 13;

FIG. 15 is a diagram schematically illustrating an absolute position database indicating the absolute position of the fixed devices according to the fourth embodiment;

FIG. 16 is a flowchart for explaining the operation of the wireless distance measuring system according to the fourth embodiment;

FIG. 17 is a diagram illustrating a functional configuration of a fixed device according to the fifth embodiment;

FIG. 18 is a flowchart for explaining the operation of the wireless distance measuring system according to the fifth embodiment;

FIG. 19 is a diagram illustrating a functional configuration of a fixed device according to the sixth embodiment;

FIG. 20 is a flowchart for explaining the operation of the wireless distance measuring system according to the sixth embodiment;

FIG. 21 is a diagram illustrating dedicated hardware for implementing the functions of the fixed device and the mobile device according to the first to seventh embodiments; and

FIG. 22 is a diagram illustrating a configuration of the control circuit for implementing the functions of the fixed device and the mobile device according to the first to seventh embodiments.

### DETAILED DESCRIPTION OF THE PREFERRED EMBODIMENTS

Hereinafter, a communication device, a wireless distance measuring system, a control circuit, a storage medium, and an anomaly detection method according to embodiments of the present disclosure will be described in detail with reference to the drawings. In the following description, in cases where a plurality of components having similar functions are distinguished from each other, they are distinguished by being denoted by a common reference sign followed by a hyphen and a number. In addition, in cases where a plurality of components having similar functions and having partially different functions are distinguished from each other, the components are distinguished by being denoted by a common reference sign followed by an alphabet letter. In cases where these components need not be distinguished from each other, these are denoted by only a common reference sign.

### First Embodiment

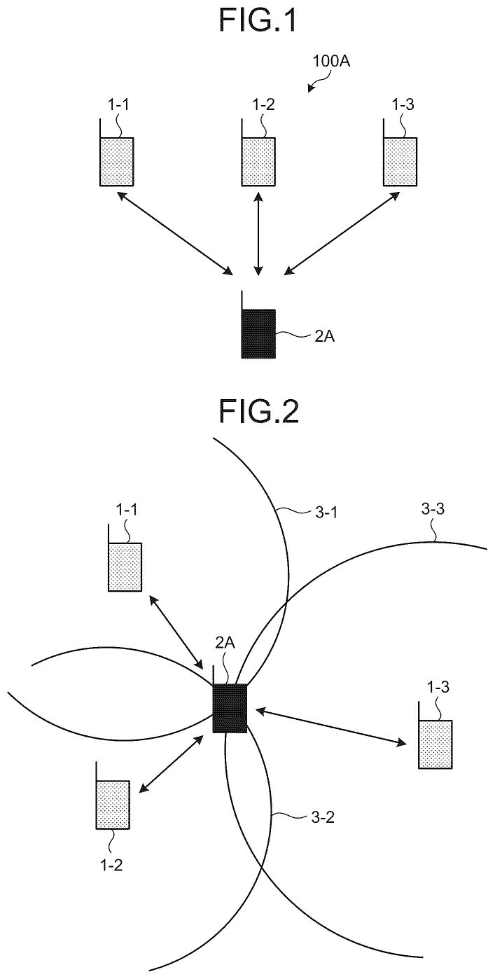

FIG. 1 is a diagram schematically illustrating a wireless distance measuring system 100A according to a first embodiment. The wireless distance measuring system 100A includes fixed devices 1-1 to 1-3 fixed on the ground and a mobile device 2A the absolute position of which changes. The mobile device 2A is an example of a communication device having a function of wirelessly communicating with the plurality of fixed devices 1. The mobile device 2A has a function of estimating the position of the mobile device 2A by measuring the distance to each of the plurality of fixed devices 1 using the transmission/reception timing of wireless signals transmitted/received to/from each of the plurality of fixed devices 1.

Although three fixed devices 1-1 to 1-3 and one mobile device 2A are illustrated here for simplicity, the wireless distance measuring system 100A may include four or more fixed devices 1 or may include two or more mobile devices 2A.

FIG. 2 is a diagram for schematically explaining a method of estimating the position of the mobile device 2A in the wireless distance measuring system 100A illustrated in FIG. 1. If the distance between the mobile device 2A and the fixed device 1-1 can be measured, it is found that the mobile device 2A is located somewhere on a circumference 3-1 with a radius of the distance measured around the fixed device 1-1. Similarly, if the distance between the mobile device 2A and the fixed device 1-2 can be measured, it is found that the mobile device 2A is located somewhere on a circumference 3-2 with a radius of the distance measured around the fixed device 1-2. Similarly, if the distance between the mobile device 2A and the fixed device 1-3 can be measured, it is found that the mobile device 2A is located somewhere on a circumference 3-3 with a radius of the distance measured around the fixed device 1-3. Therefore, if the distance between each of the three fixed devices 1-1 to 1-3 and the mobile device 2A is known, it is found that the mobile device 2A is located at the intersection of the circumferences 3-1, 3-2, and 3-3. That is, the mobile device 2A can estimate the position of the mobile device 2A by calculating the distance to three or more fixed devices 1.

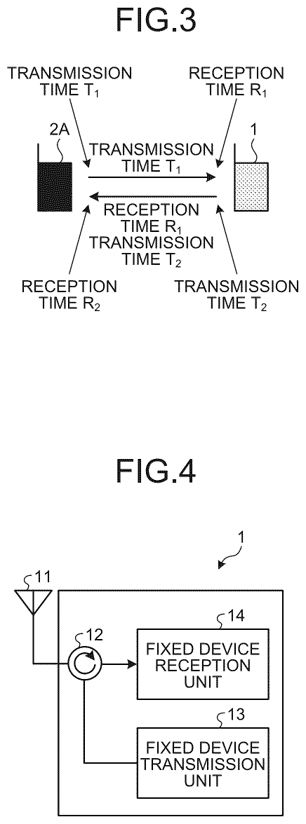

Here, an example of a specific method with which the mobile device 2A calculates the distance to the fixed device 1 will be described. Here, a method called Two Way Ranging (TWR) will be described. FIG. 3 is a diagram for explaining a specific method of estimating the position of the mobile device 2A in the wireless distance measuring system 100A illustrated in FIG. 1. First, the mobile device 2A transmits transmission time data including its transmission time T₁ to the fixed device 1. In addition to the reception time R₁ at which the transmission time data was received, the fixed device 1 responds by adding the transmission time T₂ at which a response is returned to the mobile device 2A. Because the mobile device 2A can grasp the reception time R₂ at which the response from the fixed device 1 was received, the mobile device 2A can consequently grasp time data such as the transmission time T₁, the reception time R₁, the transmission time T₂, and the reception time R₂.

The distance between the fixed device 1 and the mobile device 2A can be calculated from the propagation delay time between the fixed device 1 and the mobile device 2A. The propagation delay time can be calculated with two methods of R₁-T₁ and R₂-T₂ using the above time data. The average value T_{D} of these two propagation delay times is expressed by Formula (1) below.

$${T}_{D} = \{ ( {R}_{1} - {T}_{1} ) + ( {R}_{2} - {T}_{2} ) \} \div 2 \qquad ( 1 )$$

Here, in a case where the time synchronization is not sufficient between the fixed device 1 and the mobile device 2A, there is a difference between the time at the fixed device 1 and the time at the mobile device 2A. Provided that the time at the fixed device 1 is shifted from the time at the mobile device 2A by a, R₁ may be set to R₁+α, and T₂ may be set to T₂+α. Considering the time difference α, the average value T_{D} of the propagation delay time is expressed by Formula (2) below.

$$\begin{matrix}{T}_{D} = [ \{ ( {R}_{1} + α ) - {T}_{1} ) \} + \{ {R}_{2} - ( {T}_{2} + α ) \} ] \div 2 \\ = \{ ( {R}_{1} - {T}_{1} ) + ( {R}_{2} - {T}_{2} ) \} \div 2\end{matrix} \qquad ( 2 )$$

That is, even if the time difference α exists between the time at the fixed device 1 and the time at the mobile device 2A, a is canceled out by taking the average value T_{D}, and Formula (2) becomes the same as Formula (1). Therefore, the propagation delay time between the fixed device 1 and the mobile device 2A can be correctly calculated regardless of the value of the time difference α. Therefore, by taking the average value T_{D}, the distance can be accurately calculated from the propagation delay time.

Note that in a system in which the time at the fixed device 1 and the time at the mobile device 2A are synchronized with each other, if the time difference a is zero, it is not necessary to communicate the time data of the transmission time and the reception time as described above. Instead, for example, the time at which a signal is transmitted may be determined in advance, whereby the propagation delay time can be easily calculated by observing the reception time on the reception side. In addition, the distance can be calculated at the mobile device 2A simply from the degree of attenuation of the reception power of the transmission signal from the fixed device 1. Thus, a plurality of methods are conceivable for measuring a distance using a wireless signal, and any distance calculation method may be used in the wireless distance measuring system 100.

Here, an example has been described in which the position of the mobile device 2A is estimated by aggregating a plurality of pieces of distance information in the mobile device 2A. However, each fixed device 1 may estimate the distance to the mobile device 2A based on a response signal from the mobile device 2A, and the position of the mobile device 2A may be estimated by aggregating a plurality of pieces of distance information in the fixed device 1.

Note that any wireless signal may be used between the fixed device 1 and the mobile device 2A, but it is desirable to use an ultra-wide band (UWB) signal, for example. The UWB signal is an ultrashort pulse signal in the time domain, and the transmission/reception timing of communication can be grasped with high accuracy by using the UWB signal, so that highly accurate distance measurement can be performed.

Hereinafter, the wireless distance measuring system 100A will be described as a train position detection system. In this case, the fixed device 1 is installed along a track, and the mobile device 2A is installed on a train. The position of the train can be estimated by estimating the position of the mobile device 2A installed on the train. In addition, the train, which travels on the track, can be considered to move on a predetermined route in substantially one dimension.

FIG. 4 is a diagram illustrating a functional configuration of the fixed device 1 according to the first embodiment. The fixed device 1 includes an antenna 11, a circulator 12, a fixed device transmission unit 13, and a fixed device reception unit 14. The antenna 11 is connected to the circulator 12, outputs a reception signal from the outside of the fixed device 1 to the circulator 12, and transmits a transmission signal input from the circulator 12 to a device outside the fixed device 1. The circulator 12 has a function of demultiplexing the transmission signal and the reception signal. The circulator 12 outputs the transmission signal input from the fixed device transmission unit 13 to the antenna 11, and outputs the reception signal input from the antenna 11 to the fixed device reception unit 14.

The fixed device transmission unit 13 transmits a signal through the circulator 12 and the antenna 11. The fixed device 1 not only transmits a signal necessary for calculating the distance between the fixed device 1 and the mobile device 2A to the mobile device 2A, but also transmits an identifier with which the fixed device 1 can be identified. By associating the identifier with the absolute position information of the fixed device 1 in advance, transmitting the identifier enables the mobile device 2A to grasp the absolute position information of each fixed device 1. Further, the fixed device 1 may directly transmit the absolute position information itself to the mobile device 2A. The fixed device reception unit 14 receives a wireless signal transmitted from the mobile device 2A via the antenna 11 and the circulator 12.

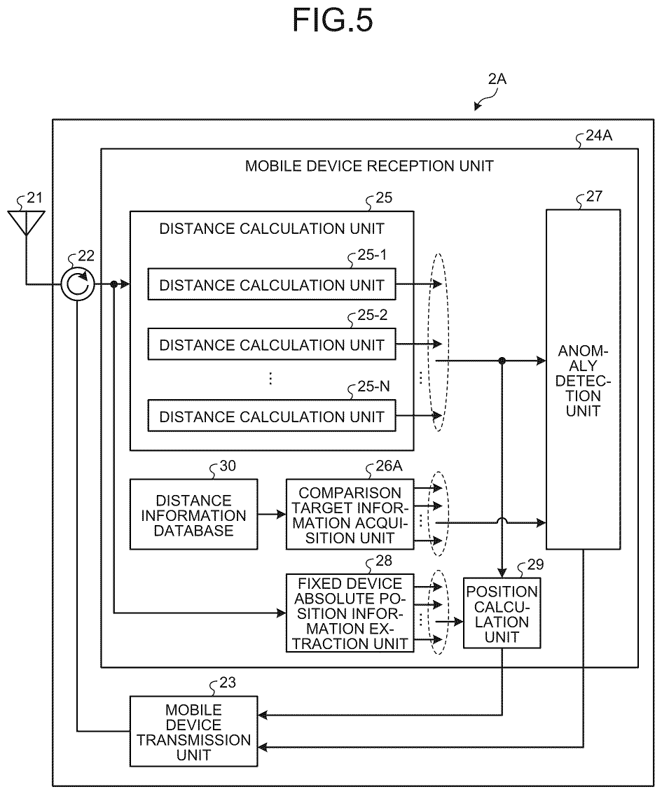

FIG. 5 is a diagram illustrating a functional configuration of the mobile device 2A according to the first embodiment. The mobile device 2A includes an antenna 21, a circulator 22, a mobile device transmission unit 23, and a mobile device reception unit 24A. The antenna 21 is connected to the circulator 22, outputs a reception signal from the outside of the mobile device 2A to the circulator 22, and transmits a transmission signal input from the circulator 22. The circulator 22 has a function of demultiplexing the transmission signal and the reception signal. The circulator 22 outputs the transmission signal input from the mobile device transmission unit 23 to the antenna 21, and outputs the reception signal input from the antenna 21 to the mobile device reception unit 24A.

The mobile device transmission unit 23 transmits a signal through the circulator 22 and the antenna 21. The mobile device reception unit 24A receives a wireless signal transmitted from the fixed device 1 via the antenna 21 and the circulator 22. The mobile device reception unit 24A includes a distance calculation unit 25, a comparison target information acquisition unit 26A, an anomaly detection unit 27, a fixed device absolute position information extraction unit 28, a position calculation unit 29, and a distance information database 30.

The distance calculation unit 25 calculates the distance between the fixed device 1 and the mobile device 2A based on the reception signal from the fixed device 1. The distance calculation unit 25 includes distance calculation units 25-1 to 25-N, and the distance calculation units 25-1 to 25-N calculate the distance to the N fixed devices 1-1 to 1-N, respectively. Specifically, the distance calculation unit 25-1 calculates the distance between the fixed device 1-1 and the mobile device 2A, the distance calculation unit 25-2 calculates the distance between the fixed device 1-2 and the mobile device 2A, and the distance calculation unit 25-N calculates the distance between the fixed device 1-N and the mobile device 2A. Here, N is an integer of three or more. The distance calculation unit 25 outputs the calculated distances to both the anomaly detection unit 27 and the position calculation unit 29.

The comparison target information acquisition unit 26A acquires comparison target information to be used by the anomaly detection unit 27, and outputs the acquired comparison target information to the anomaly detection unit 27. The comparison target information is information prepared in advance based on the scheduled position of a communication device having an anomaly detection function, and in the first embodiment, is distance information indicating the distance that changes with time between the fixed device 1 and the mobile device 2A and calculated based on the scheduled travel route of the mobile device 2A. The comparison target information acquisition unit 26A can acquire the distance information from the distance information database 30 included in the mobile device 2A, and output the distance information to the anomaly detection unit 27 as the comparison target information. Here, because the position of the mobile device 2A changes with the movement of the train, the distance information indicates the transition of the distance that changes with the movement of the mobile device 2A. The comparison target information acquisition unit 26A can acquire comparison target information for each fixed device 1, and output a plurality of pieces of comparison target information.

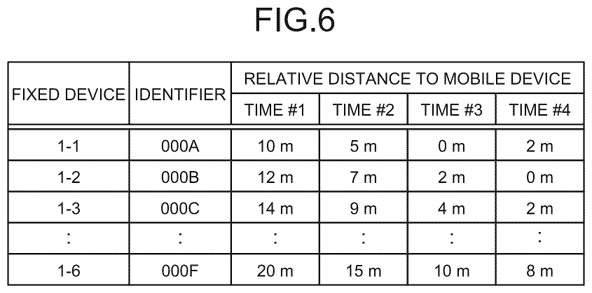

FIG. 6 is a diagram illustrating an example of the distance information database 30 illustrated in FIG. 5. Here, a case where N=6 is illustrated. The distance information database 30 indicates a temporal change in the distance between each of the fixed devices 1-1 to 1-6 and the mobile device 2A. In the distance information database 30, the identifier of each of the fixed devices 1-1 to 1-6 is associated with the relative distance between each of the fixed devices 1-1 to 1-6 and the mobile device 2A at times #1 to #4.

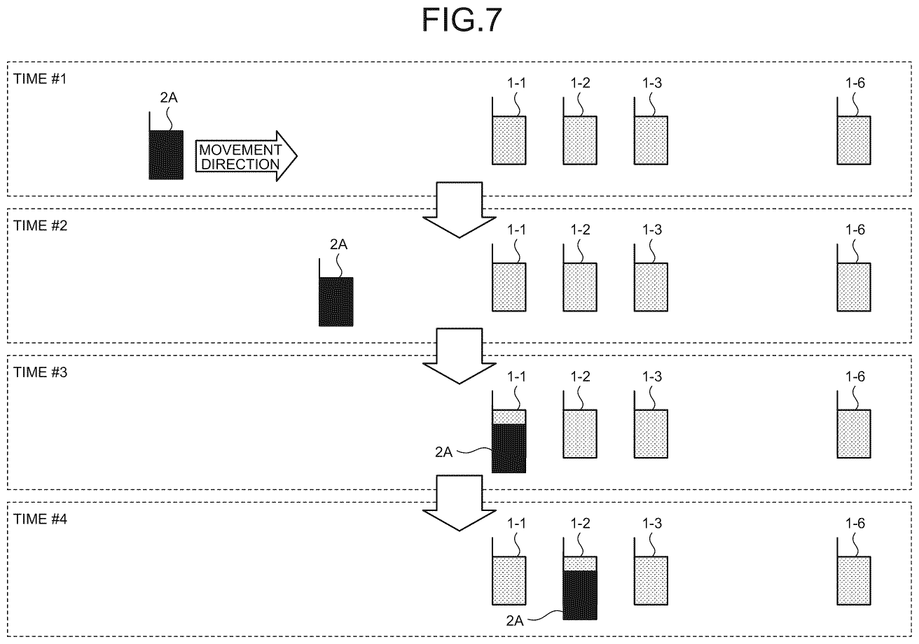

FIG. 7 is a diagram illustrating an example of a temporal change in the positional relationship between the fixed device 1 and the mobile device 2A. The times #1 to #4 illustrated in FIG. 7 correspond to the times #1 to #4 illustrated in FIG. 6. For example, suppose that the mobile device 2A is located 10 m away from the fixed device 1-1 at time #1. Also suppose that the fixed devices 1-1 to 1-6 are installed in the order of the fixed devices 1-1, 1-2, 1-3, 1-4, 1-5, and 1-6 in order of proximity from the position of the mobile device 2A at time #1. For simplicity, the fixed devices 1-4 and 1-5 are omitted in FIGS. 6 and 7. The fixed device 1-2 is installed 2 m away from the fixed device 1-1, the fixed device 1-3 is installed 4 m away from the fixed device 1-1, and the fixed device 1-6 is installed 10 m away from the fixed device 1-1.

In this case, at time #1, the distance between the mobile device 2A and the fixed device 1-1 is 10 m, the distance between the mobile device 2A and the fixed device 1-2 is 12 m, the distance between the mobile device 2A and the fixed device 1-3 is 14 m, and the distance between the mobile device 2A and the fixed device 1-6 is 20 m.

The mobile device 2A moves from the state at time #1 to the right in FIG. 7 in the direction approaching the fixed device 1-1, and the mobile device 2A gets within a distance of 5 m to the fixed device 1-1 at time #2. Here, the distance between the mobile device 2A and the fixed device 1-2 becomes 7 m, the distance between the mobile device 2A and the fixed device 1-3 becomes 9 m, and the distance between the mobile device 2A and the fixed device 1-6 becomes 15 m.

Subsequently, the mobile device 2A further moves in the same direction, and the distance between the mobile device 2A and the fixed device 1-1 becomes zero at time #3. Here, the distance between the mobile device 2A and the fixed device 1-2 becomes 2 m, the distance between the mobile device 2A and the fixed device 1-3 becomes 4 m, and the distance between the mobile device 2A and the fixed device 1-6 becomes 10 m. Until time #3, the distances between the mobile device 2A and the fixed devices 1-1 to 1-6 all decrease with time.

Further, the mobile device 2A moves in the same direction, and the distance between the mobile device 2A and the fixed device 1-2 becomes zero at time #4. Here, the distance between the mobile device 2A and the fixed device 1-1 increases to 2 m, the distance between the mobile device 2A and the fixed device 1-3 becomes 2 m, and the distance between the mobile device 2A and the fixed device 1-6 becomes 8 m.

In this manner, as for the distance between each of the fixed devices 1-1 to 1-6 fixed on the ground and the mobile device 2A, if the movement route of the mobile device 2A is determined in advance, the increase/decrease pattern is determined in advance. In addition, the order in which the fixed devices 1-1 to 1-6 are seen from the mobile device 2A is also determined in advance. Here, the order in which the fixed devices 1-1 to 1-6 are seen from the mobile device 2A is the order in which the distance to the mobile device 2A falls to or below the threshold, for example, the order in which the distance to the mobile device 2A becomes zero. In the example illustrated in FIG. 7, this order is the order of the fixed devices 1-1, 1-2, 1-3, 1-4, 1-5, and 1-6.

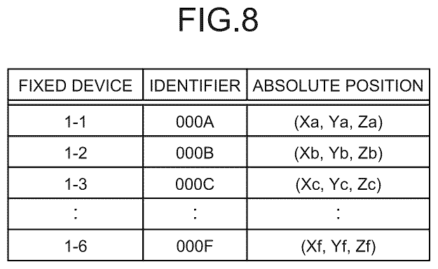

As described above, if the movement route of the mobile device 2A is determined in advance, the distance information indicating the distance between the mobile device 2A and the fixed device 1 can be generated by converting the absolute position information of the fixed device 1. FIG. 8 is a diagram schematically illustrating an absolute position database indicating the absolute position of the fixed device 1 according to the first embodiment. The absolute position database includes an identifier for identifying each of the plurality of fixed devices 1 and the absolute position of each fixed device 1. For example, it is found from the absolute position database that the absolute position of the fixed device 1-1 identified with the identifier “000A” is (Xa, Ya, Za). Because the mobile device 2A is installed on the train, moves one-dimensionally along the track, and the fixed device 1 is installed along the track, the fixed device 1 approaches in a predetermined order as viewed from the mobile device 2A. Therefore, the distance information database 30 illustrated in FIG. 6 can be generated in advance by converting the information of the absolute position database illustrated in FIG. 8 based on the movement route of the mobile device 2A.

The anomaly detection unit 27 can detect an anomaly occurring in the position of the fixed device 1 based on whether the distance calculated by the distance calculation unit 25 matches the comparison target information output from the comparison target information acquisition unit 26. Upon detecting an anomaly occurring in the position of the fixed device 1, the anomaly detection unit 27 outputs the occurrence of the anomaly and detailed information on the anomaly to the mobile device transmission unit 23. Specifically, in a case where the comparison target information is the distance between each fixed device 1 and the mobile device 2A associated with the time as illustrated in FIG. 6, the anomaly detection unit 27 can compare the distance associated with the current time with the distance calculated by the distance calculation unit 25 and determine that an anomaly has occurred in response to detecting a mismatch between the two. For example, when the difference between the distance associated with the current time and the distance calculated by the distance calculation unit 25 is equal to or larger than a predetermined threshold, the anomaly detection unit 27 can determine that the distances do not match. Note that the detailed information can include the identifier of the fixed device 1 in which the anomaly is determined to have occurred. The detailed information can also include information indicating what kind of anomaly has occurred, for example, information indicating whether the calculated distance is different from the content of the database, information indicating whether there is no response from the fixed device 1 and the distance cannot be calculated, and the like.

The fixed device absolute position information extraction unit 28 extracts the absolute position information of the fixed device 1 based on the reception signal from the fixed device 1, and outputs the extracted absolute position information to the position calculation unit 29. In a case where the fixed device 1 transmits the absolute position information itself to the mobile device 2A, the fixed device absolute position information extraction unit 28 extracts the absolute position information from the reception signal from the fixed device 1. In a case where the fixed device 1 transmits the identifier of the fixed device 1 to the mobile device 2A, the fixed device absolute position information extraction unit 28 holds an absolute position database such as the one illustrated in FIG. 8 in advance, extracts the identifier included in the reception signal from the fixed device 1, and extracts the absolute position associated with the extracted identifier from the absolute position database.

The position calculation unit 29 estimates the position of the mobile device 2A based on the measurement results of the plurality of distances output from the distance calculation unit 25 and the absolute position information of the fixed device 1 output from the fixed device absolute position information extraction unit 28. The position calculation unit 29 outputs the calculated position estimation result to the mobile device transmission unit 23.

Note that the detailed information regarding the anomaly output from the anomaly detection unit 27 and the estimation result of the position of the mobile device 2A output from the position calculation unit 29 are transmitted from the mobile device transmission unit 23 to an external device such as the fixed device 1 or a control server (not illustrated).

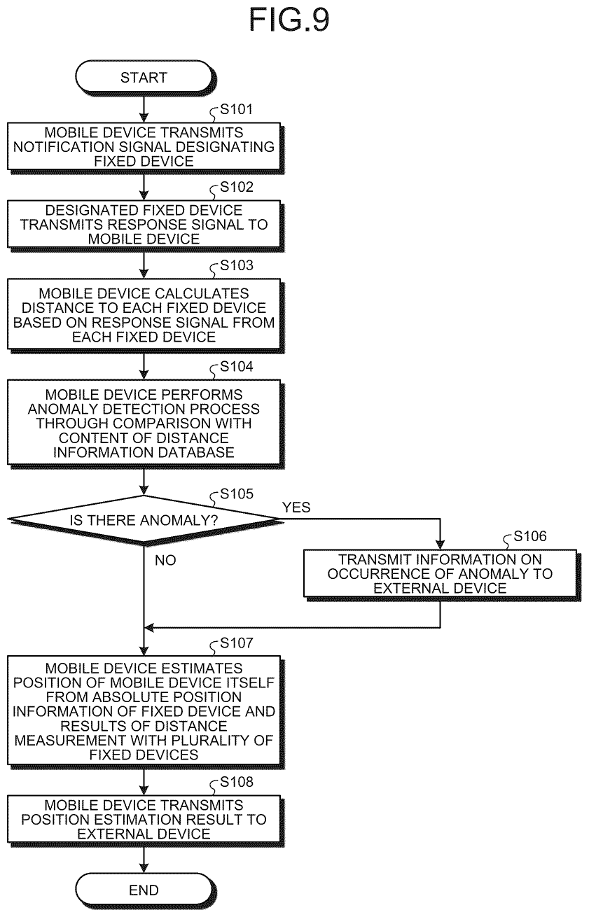

FIG. 9 is a flowchart for explaining the operation of the wireless distance measuring system 100A according to the first embodiment. The mobile device 2A transmits a notification signal designating the fixed device 1 from which the mobile device 2A wants a response (step S101). At this time, the mobile device 2A can designate a plurality of fixed devices 1. The designated fixed device 1 transmits a response signal to the mobile device 2A (step S102)

The distance calculation unit 25 of the mobile device 2A calculates the distance to each fixed device 1 based on the response signal from each fixed device 1 (step S103). The anomaly detection unit 27 of the mobile device 2A performs the anomaly detection process related to the position of the fixed device 1 by comparing the calculated distance with the content of the distance information database 30 (step S104). The anomaly detection unit 27 of the mobile device 2A determines whether there is an anomaly in the position of the fixed device 1 (step S105). In response to determining that there is an anomaly (step S105: Yes), the anomaly detection unit 27 transmits information on the occurrence of the anomaly to an external device such as the fixed device 1 or a control server (step S106).

In response to determining that there is no anomaly (step S105: No), or after the processing in step S106, the position calculation unit 29 of the mobile device 2A estimates the position of the mobile device 2A itself from the absolute position information of the fixed device 1 and the results of distance measurement with the plurality of fixed devices 1 (step S107). The position calculation unit 29 of the mobile device 2A transmits the position estimation result to an external device such as the fixed device 1 or a control server (step S108).

Although the mobile device 2A is configured to estimate the position by aggregating the distance information with respect to the plurality of fixed devices 1 in the above description, each fixed device 1 may estimate the distance to the mobile device 2A based on the response signal from the mobile device 2A, and estimate the position of the mobile device 2A by aggregating the results of estimation of the plurality of distances in the fixed device 1.

As described above, the mobile device 2A according to the first embodiment is a communication device that wirelessly communicates with the fixed device 1 fixed on the ground, and includes: the distance calculation unit to 25 that calculates the distance between the fixed device 1 and the mobile device 2A that is the communication device based on a reception signal from the fixed device 1; the comparison target information acquisition unit 26A that acquires comparison target information that is information indicating the distance between the fixed device 1 and the mobile device 2A that is the communication device, the information being prepared in advance based on the scheduled position of the mobile device 2A that is the communication device; and the anomaly detection unit 27 that detects an anomaly occurring in the position of the fixed device 1 based on the distance calculated by the distance calculation unit 25 and the comparison target information. Here, the mobile device 2A includes the distance information database 30 including distance information that is the comparison target information, and the comparison target information acquisition unit 26A acquires the distance information that is the comparison target information from the distance information database 30 included in the mobile device 2A. With such a configuration, the mobile device 2A can detect an anomaly occurring in the position of the fixed device 1 based on the comparison target information that is information prepared in advance and the distance calculated based on the reception signal from the fixed device 1. Therefore, even in a place where GPS positioning cannot be performed, it is possible to detect an anomaly related to the position of the fixed device 1. This brings about the effect of making it possible to quickly deal with an anomaly such as movement, theft, or failure of the fixed device 1. In addition, performing the anomaly detection process in the mobile device 2A brings about the effect of making it possible to detect an anomaly occurring in the position of the fixed device 1 without adding a new device to the wireless distance measuring system 100.

### Second Embodiment

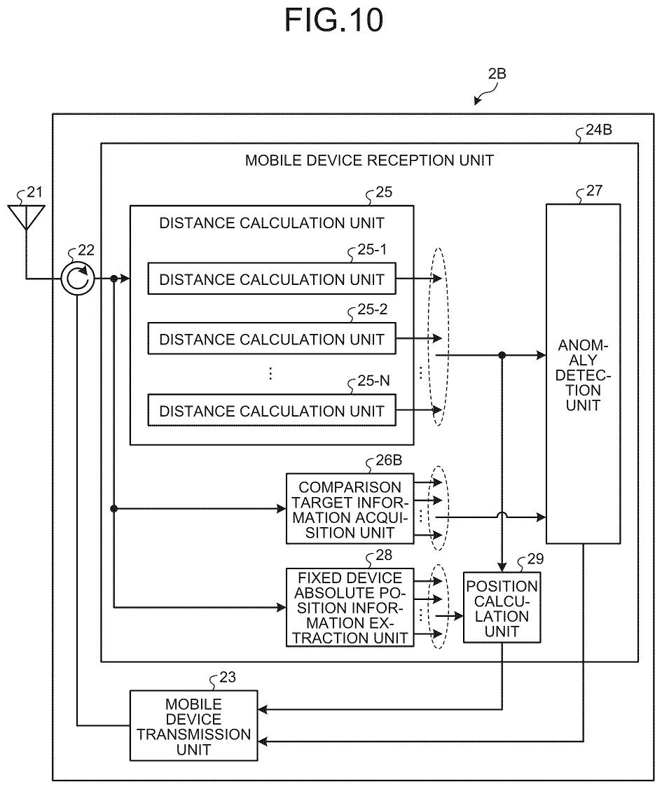

FIG. 10 is a diagram illustrating a functional configuration of a mobile device 2B according to a second embodiment. Because the configuration of the fixed device 1 according to the second embodiment is the same as that in the first embodiment, the description thereof is omitted here. In addition, in the functional configuration of the mobile device 2B, components similar to those in the first embodiment are denoted by the same reference signs as those in FIG. 5, and a detailed description thereof will be omitted. Hereinafter, components different from those of the mobile device 2A according to the first embodiment will be mainly described. Note that a system obtained by replacing the mobile device 2A of the wireless distance measuring system 100A according to the first embodiment with the mobile device 2B is referred to as the wireless distance measuring system 100B.

The mobile device 2B includes the antenna 21, the circulator 22, the mobile device transmission unit 23, and a mobile device reception unit 24B. The mobile device reception unit 24B includes the distance calculation unit 25, a comparison target information acquisition unit 26B, the anomaly detection unit 27, the fixed device absolute position information extraction unit 28, and the position calculation unit 29.

The comparison target information acquisition unit 26B acquires the comparison target information stored outside the mobile device 2B. Specifically, the comparison target information acquisition unit 26B acquires the comparison target information by extracting the comparison target information from the reception signal, and outputs the acquired comparison target information to the anomaly detection unit 27. The comparison target information is stored in, for example, an external device such as the fixed device 1, a control server, or a cloud server, and the comparison target information acquisition unit 26B extracts the comparison target information from a reception signal from the external device.

In the second embodiment, the functional configuration of the fixed device 1 is similar to that in the first embodiment, which has been described using FIG. 4, and thus the description is omitted here.

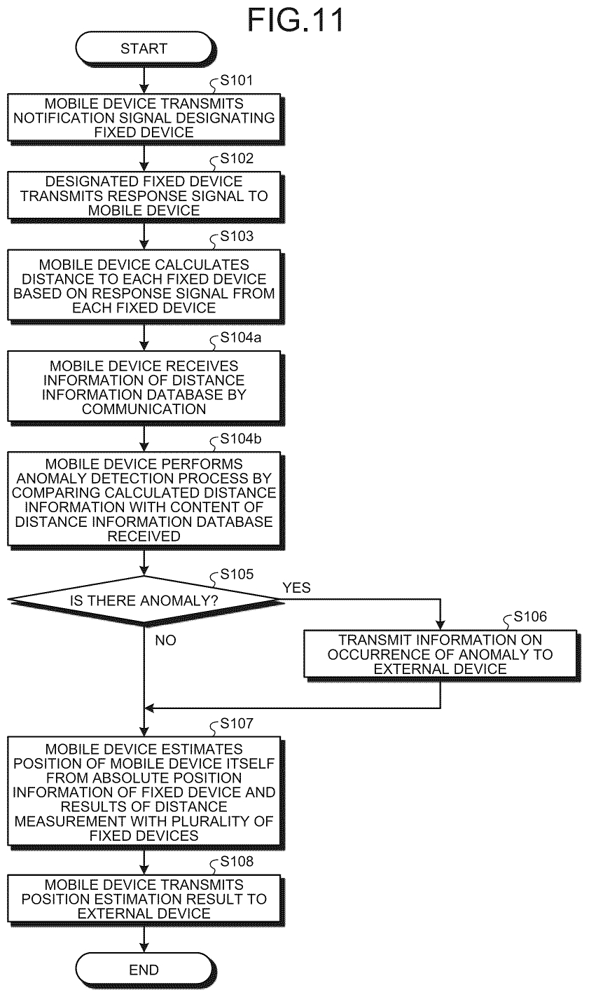

FIG. 11 is a flowchart for explaining the operation of the wireless distance measuring system 100B according to the second embodiment. Because steps S101 to S103 and steps S105 to S108 are similar to those in the first embodiment, the description thereof is omitted here, and differences from the first embodiment will be mainly described. After the processing in step S103 is completed, the mobile device 2B receives the information of the distance information database 30 from the external device by communication (step S104a). The anomaly detection unit 27 of the mobile device 2B performs an anomaly detection process by comparing the calculated distance information with the content of the distance information database that is the received comparison target information (step S104b).

As described above, the comparison target information acquisition unit 26B of the mobile device 2B according to the second embodiment acquires the distance information, which is the comparison target information, from the reception signal. With such a configuration, a change in the arrangement of the fixed devices 1 and the resultant change in the content of the distance information database 30 which is the comparison target information can be dealt with simply by updating only the content of the distance information database 30 held by an external device such as the fixed device 1 on the ground side, a control server, or a cloud server, which brings about the effect of making it possible to save time and effort to update the database of every mobile device 2B.

In the above description, the comparison target information acquisition unit 26B acquires the comparison target information using the same wireless communication means as when the mobile device 2B transmits and receives a wireless signal in order to estimate the distance to the fixed device 1. However, for example, different wireless communication means such as cellular communication may be used.

### Third Embodiment

In the first and second embodiments, the mobile devices 2A and 2B detect an anomaly for all the fixed devices 1 on the travel route in one travel. However, a mobile device 2C (not illustrated) according to a third embodiment places a limitation on the fixed devices 1 to be set as anomaly detection targets in one travel. Note that a system obtained by replacing the mobile device 2A of the wireless distance measuring system 100A with the mobile device 2C is referred to as the wireless distance measuring system 100C. For example, suppose that a train that is a mobile object equipped with the mobile device 2C moves at a high speed. In this case, if all the fixed devices 1 are set as anomaly detection targets in the presence of an extremely large number of fixed devices 1, the amount of calculation processing for anomaly detection can be too large. Therefore, for example, in a case where the fixed devices 1-1, 1-2, 1-3, 1-4, . . . , and 1-10 are installed on the travel route of the mobile device 2, the mobile device 2C may adopt a method of setting only the fixed device 1-1 as the anomaly detection target in the first travel and setting only the fixed device 1-2 as the anomaly detection target in the next travel. Note that the mobile device 2C does not necessarily set anomaly detection targets one by one, and the number of the fixed devices 1 to be set as anomaly detection targets at the same time among the installed fixed devices 1 can be limited according to the system configuration or the state of the system.

As described above, with the wireless distance measuring system 100C according to the third embodiment, the mobile device 2C can limit the number of fixed devices 1 to be set as anomaly detection targets in one travel. Such a configuration brings about the effect of making it possible to reduce the peak value of the amount of calculation processing for anomaly detection as compared with the case where the anomaly detection process for all the fixed devices 1 is performed in one travel.

### Fourth Embodiment

In the first to third embodiments, the communication devices that perform the anomaly detection process are the mobile devices 2A, 2B, and 2C, but in this case, there is a problem that the anomaly detection cannot be performed unless the mobile devices 2A, 2B, and 2C move. Therefore, a fourth embodiment describes an example in which the communication device that performs the anomaly detection process is the fixed device 1.

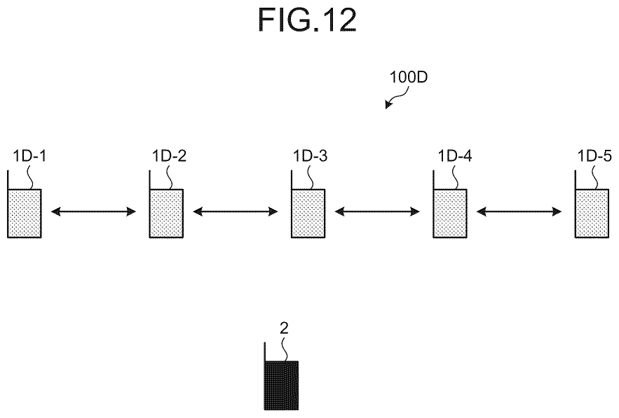

FIG. 12 is a diagram illustrating an exemplary configuration of a wireless distance measuring system 100D according to the fourth embodiment. The wireless distance measuring system 100D includes a plurality of fixed devices 1D-1 to 1D-5 and a mobile device 2. The fixed devices 1D-1 to 1D-5 estimate their positions based on wireless signals transmitted and received to and from each other. At this time, communication with the mobile device 2 is not required. Not all the fixed devices 1D included in the wireless distance measuring system 100D need to have the anomaly detection function, but the following description is based on the assumption that all the fixed devices 1D have the anomaly detection function. Although FIG. 12 illustrates five fixed devices 1D, the number of fixed devices 1D included in the wireless distance measuring system 100D only needs to be four or more, and in practice, the wireless distance measuring system 100D includes six or more fixed devices 1D.

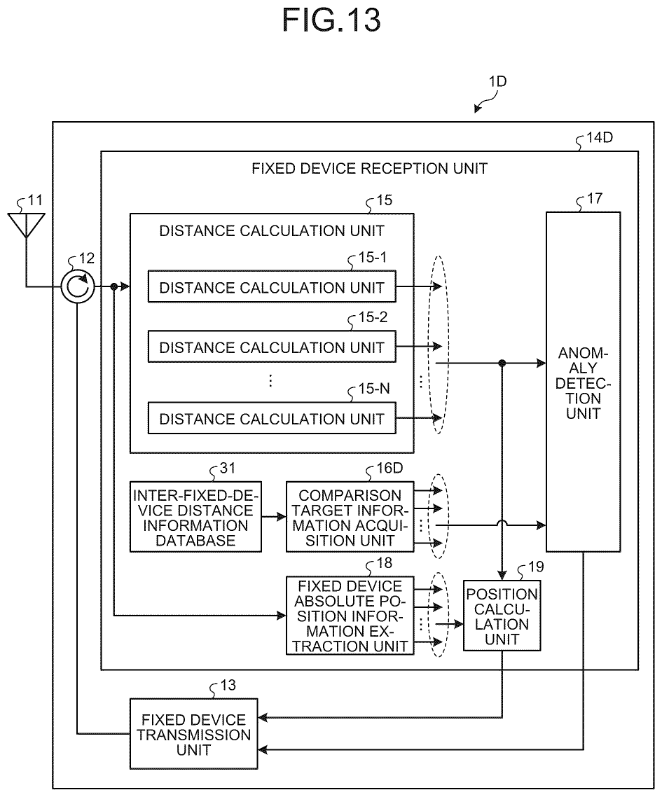

FIG. 13 is a diagram illustrating a functional configuration of the fixed device 1D according to the fourth embodiment. Hereinafter, a detailed description of functions similar to those of the fixed device 1 according to the first embodiment will be omitted, and differences will be mainly described. The fixed device 1D includes the antenna 11, the circulator 12, the fixed device transmission unit 13, and a fixed device reception unit 14D. The fixed device reception unit 14D includes the distance calculation unit 15, a comparison target information acquisition unit 16D, the anomaly detection unit 17, the fixed device absolute position information extraction unit 18, the position calculation unit 19, and an inter-fixed-device distance information database 31.

The distance calculation unit 15 calculates the distance between the fixed device 1D and other fixed devices 1D based on reception signals from the other fixed devices 1D. The distance calculation unit 15 includes distance calculation units 15-1 to 15-N, and each of the distance calculation units 15-1 to 15-N calculates the distance to the corresponding one of the other fixed devices 1D. For example, the distance calculation unit 15-1 calculates the distance to the fixed device 1D-1. The distance calculation unit 15 outputs the calculated distance to both the anomaly detection unit 17 and the position calculation unit 19.

The comparison target information acquisition unit 16D acquires comparison target information that is used by the anomaly detection unit 17. The comparison target information acquisition unit 16D acquires distance information between the fixed devices 1D, which is comparison target information, from the inter-fixed-device distance information database 31. In the fourth embodiment, the comparison target information is the distance information between the target fixed device 1D and another fixed device 1D calculated based on the scheduled position of the target fixed device 1D.

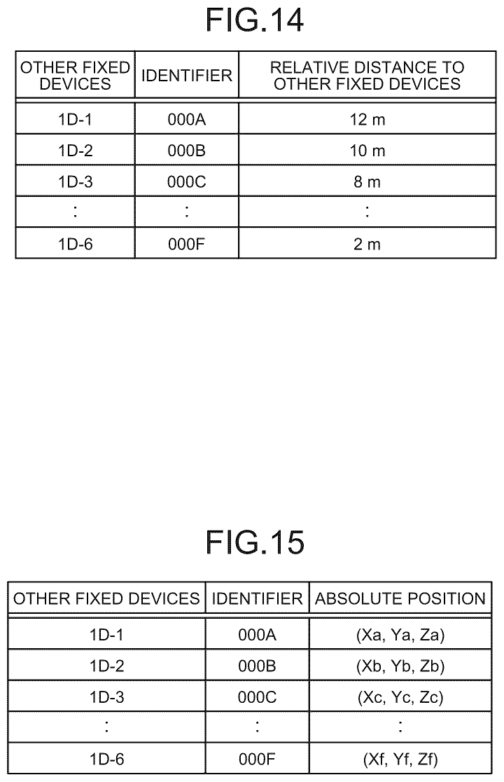

FIG. 14 is a diagram illustrating an example of the inter-fixed-device distance information database 31 illustrated in FIG. 13. In the inter-fixed-device distance information database 31, an identifier for identifying each of the other fixed devices 1D-1 to 1D-6 different from the target fixed device 1D is associated with the relative distance between each of the other fixed devices 1D-1 to 1D-6 and the target fixed device 1D. As illustrated in FIG. 13, if the fixed device 1D itself includes the inter-fixed-device distance information database 31, the target fixed device 1D is the fixed device 1D including the inter-fixed-device distance information database 31. Because the fixed device 1D is fixed on the ground and its absolute position does not change, if the absolute position of each fixed device 1D is known, the inter-fixed-device distance information database 31 such as the one illustrated in FIG. 14 can be generated in advance. FIG. 15 is a diagram schematically illustrating an absolute position database indicating the absolute position of the fixed devices 1D-1 to 1D-6 according to the fourth embodiment. The absolute position database includes identification information for identifying each of the plurality of fixed devices 1D-1 to 1D-6, and the absolute position of each fixed device 1D. For example, it is found from the absolute position database that the absolute position of the fixed device 1D-1 identified with the ID “000A” is (Xa, Ya, Za). Because the fixed device 1D is fixed on the ground and its absolute position basically does not change, the inter-fixed-device distance information database 31 such as the one illustrated in FIG. 14 can be generated in advance by converting the information of the absolute position database such as the one illustrated in FIG. 15.

The anomaly detection unit 17 can detect an anomaly occurring in the position of the fixed device 1D based on the distance calculated by the distance calculation unit 15 and the comparison target information output from the comparison target information acquisition unit 16D. Upon detecting an anomaly occurring in the position of the fixed device 1D, the anomaly detection unit 17 outputs the occurrence of the anomaly and detailed information on the anomaly to the fixed device transmission unit 13. Specifically, in a case where the comparison target information is the distance between the fixed devices 1D as illustrated in FIG. 14, the anomaly detection unit 17 can compare the distance that is the comparison target information with the distance calculated by the distance calculation unit 15, and determine that an anomaly has occurred in response to detecting a mismatch between the two. When the difference between the distance that is the comparison target information and the distance calculated by the distance calculation unit 15 is equal to or larger than a predetermined threshold, the anomaly detection unit 17 can determine that the distances do not match. Note that the detailed information can include the identifier of the fixed device 1D in which the anomaly is determined to have occurred. The detailed information can also include information indicating what kind of anomaly has occurred, for example, information indicating whether the calculated distance is different from the content of the database, information indicating whether there is no response from the fixed device 1D and the distance cannot be calculated, and the like.

The fixed device absolute position information extraction unit 18 extracts the absolute position information of other fixed devices 1D based on reception signals from the other fixed devices 1D, and outputs the extracted absolute position information to the position calculation unit 19. In a case where the other fixed devices 1D transmit the absolute position information itself to the target fixed device 1D, the fixed device absolute position information extraction unit 18 extracts the absolute position information from the reception signals from the other fixed devices 1D. In a case where the other fixed devices 1D transmit the identifier of the fixed devices 1D to the target fixed device 1D, the fixed device absolute position information extraction unit 18 holds an absolute position database such as the one illustrated in FIG. 15 in advance, extracts the identifier included in the reception signals from the other fixed devices 1D, and extracts the absolute position associated with the extracted identifier from the absolute position database.

The position calculation unit 19 estimates the position of the target fixed device 1D based on the measurement results of the plurality of distances output from the distance calculation unit 15 and the absolute position information of the other fixed devices 1D output from the fixed device absolute position information extraction unit 18. The position calculation unit 19 outputs the estimation result of the calculated position to the fixed device transmission unit 13.

Note that the detailed information regarding the anomaly output from the anomaly detection unit 17 and the estimation result of the position of the target fixed device 1D output from the position calculation unit 19 are transmitted from the fixed device transmission unit 13 to an external device such as a control server. Note that transmission information such as the detailed information and the position estimation result may be directly transmitted from the fixed device 1D to a control server or the like, or the transmission information may be transmitted from the fixed device 1D to the mobile device 2 when the mobile device 2 travels under the control thereof, and the transmission information may be transmitted to an external device such as a control server via the mobile device 2.

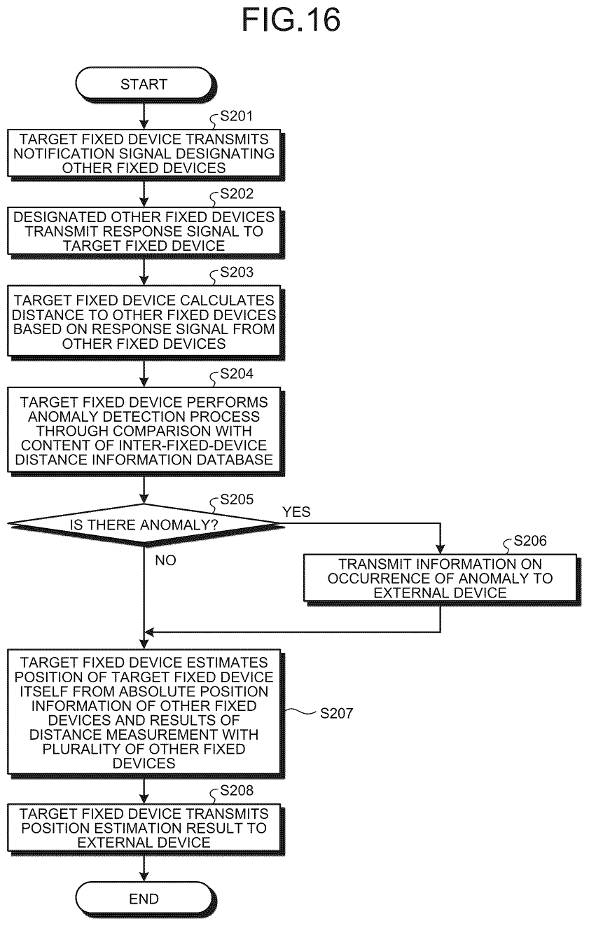

FIG. 16 is a flowchart for explaining the operation of the wireless distance measuring system 100D according to the fourth embodiment. The target fixed device 1D transmits a notification signal designating the fixed device 1D from which the target fixed device 1D wants a response (step S201). At this time, the fixed device 1D can designate a plurality of fixed devices 1D. The designated other fixed devices 1D transmit a response signal to the target fixed device 1D (step S202).

The distance calculation unit 15 of the target fixed device 1D calculates the distance to each of the other fixed devices 1D based on the response signal from the other fixed devices 1D (step S203). The anomaly detection unit 17 of the target fixed device 1D performs the anomaly detection process related to the position of the other fixed devices 1D by comparing the calculated distance with the content of the inter-fixed-device distance information database 31 (step S204). The anomaly detection unit 17 of the target fixed device 1D determines whether there is an anomaly in the position of the other fixed devices 1D (step S205). In response to determining that there is an anomaly (step S205: Yes), the anomaly detection unit 17 transmits information on the occurrence of the anomaly to an external device such as a control server (step S206).

In response to determining that there is no anomaly (step S205: No), or after the processing in step S206, the position calculation unit 19 of the target fixed device 1D estimates the position of the target fixed device 1D itself from the absolute position information of the other fixed devices 1D and the results of distance measurement with the plurality of other fixed devices 1D (step S207). The position calculation unit 19 of the target fixed device 1D transmits the position estimation result to an external device such as a control server (step S208).

As described above, the fixed device 1D according to the fourth embodiment is a communication device that wirelessly communicates with other fixed devices 1D fixed on the ground, and includes: the distance calculation unit 15 that calculates the distance between the other fixed devices 1D and the target fixed device 1D that is the communication device based on reception signals from the other fixed devices 1D; the comparison target information acquisition unit 16D that acquires comparison target information that is information prepared in advance and indicating the distance between the other fixed devices 1D and the target fixed device 1D that is the communication device; and the anomaly detection unit 17 that detects an anomaly occurring in the position of the other fixed devices 1D based on whether the distance calculated by the distance calculation unit 15 matches the comparison target information. Here, target fixed device 1D includes the inter-fixed-device distance information database 31 including distance information that is the comparison target information, and the comparison target information acquisition unit 16D acquires distance information that is the comparison target information from the inter-fixed-device distance information database 31 included in the target fixed device 1D. With such a configuration, the fixed device 1D can detect an anomaly occurring in the position of the other fixed devices 1 based on the comparison target information that is information prepared in advance and the distance calculated based on the reception signals from the other fixed devices 1. Therefore, even in a place where GPS positioning cannot be performed, it is possible to detect an anomaly related to the position of the fixed device 1D. This brings about the effect of making it possible to quickly deal with an anomaly such as movement, theft, or failure of the fixed device 1D. In addition, because the above processing can be performed in the fixed device 1D, it is possible to grasp an anomaly related to the position of the fixed device 1D even in a period of time in which the mobile device 2 is not moving.

### Fifth Embodiment

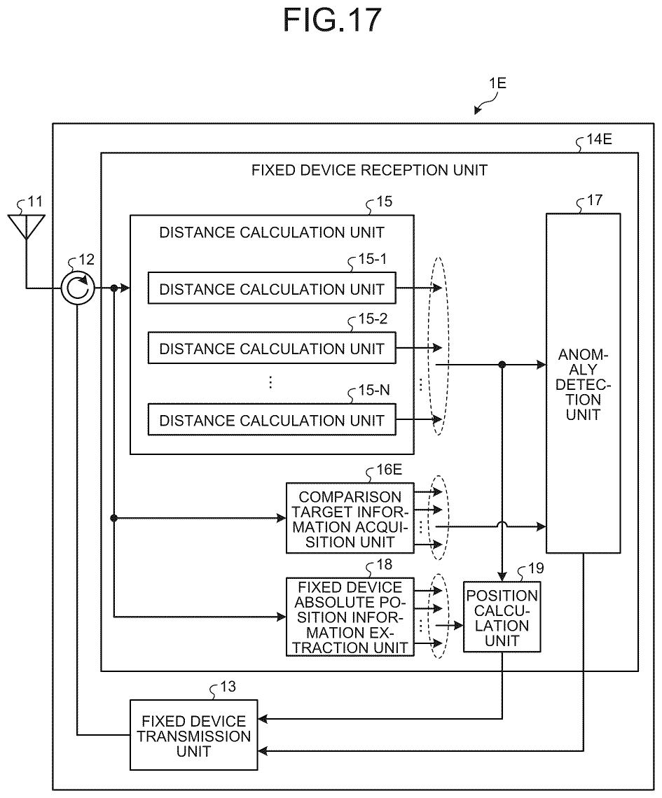

FIG. 17 is a diagram illustrating a functional configuration of a fixed device 1E according to a fifth embodiment. Hereinafter, a detailed description of functions similar to those of the fixed device 1D according to the fourth embodiment will be omitted, and differences from the fixed device 1D will be mainly described. Note that a system obtained by replacing the fixed device 1D of the wireless distance measuring system 100D according to the fourth embodiment with the fixed device 1E is referred to as the wireless distance measuring system 100E. The fixed device 1E includes the antenna 11, the circulator 12, the fixed device transmission unit 13, and a fixed device reception unit 14E. The fixed device reception unit 14E includes the distance calculation unit 15, a comparison target information acquisition unit 16E, the anomaly detection unit 17, the fixed device absolute position information extraction unit 18, and the position calculation unit 19.

The comparison target information acquisition unit 16E acquires the comparison target information stored outside the target fixed device 1E. Specifically, the comparison target information acquisition unit 16E acquires the comparison target information by extracting the comparison target information from the reception signal, and outputs the acquired comparison target information to the anomaly detection unit 17. The comparison target information is the distance information included in the inter-fixed-device distance information database 31 such as the one illustrated in FIG. 14, and stored in, for example, an external device such as a control server or a cloud server. The comparison target information acquisition unit 16E extracts the comparison target information from a reception signal from the external device.

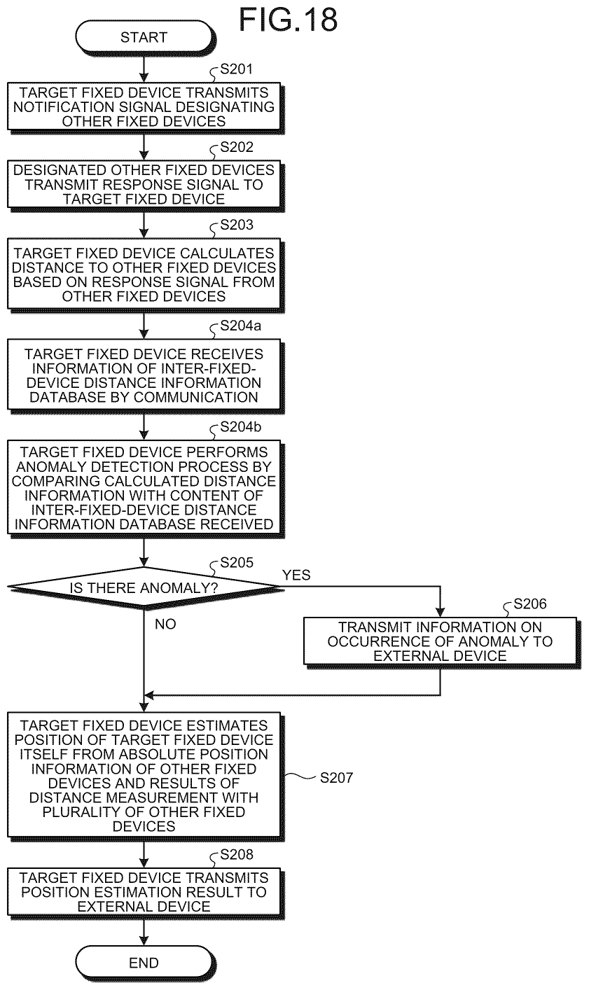

FIG. 18 is a flowchart for explaining the operation of the wireless distance measuring system 100E according to the fifth embodiment. Because steps S201 to S203 and steps S205 to S208 are similar to those in the fourth embodiment, the description thereof is omitted here, and differences from the fourth embodiment will be mainly described. After the processing in step S203 is completed, the target fixed device 1E receives the information of the inter-fixed-device distance information database 31 from the external device by communication (step S204a). The anomaly detection unit 17 of the target fixed device 1E performs an anomaly detection process by comparing the calculated distance information with the content of the inter-fixed-device distance information database 31 that is the received comparison target information (step S204b). Following the processing in step S204b, the processing in steps S205 to S208 is performed.

As described above, the comparison target information acquisition unit 16E of the fixed device 1E according to the fifth embodiment acquires the distance information, which is the comparison target information, from the reception signal. With such a configuration, a change in the arrangement of the fixed devices 1E and the resultant change in the content of the inter-fixed-device distance information database 31 which is the comparison target information can be dealt with simply by updating only the content of the inter-fixed-device distance information database 31 held by an external device such as a control server or a cloud server. Therefore, whereas the wireless distance measuring system 100D according to the fourth embodiment needs to update the database of every fixed device 1D, the wireless distance measuring system 100E according to the fifth embodiment can achieve the effect of making it possible to save time and effort for update.

In the above description, the comparison target information acquisition unit 16E acquires the comparison target information using the same wireless communication means as when the fixed device 1E transmits and receives a wireless signal in order to estimate the distance to other fixed devices 1E. However, for example, different wireless communication means such as cellular communication may be used.

### Sixth Embodiment

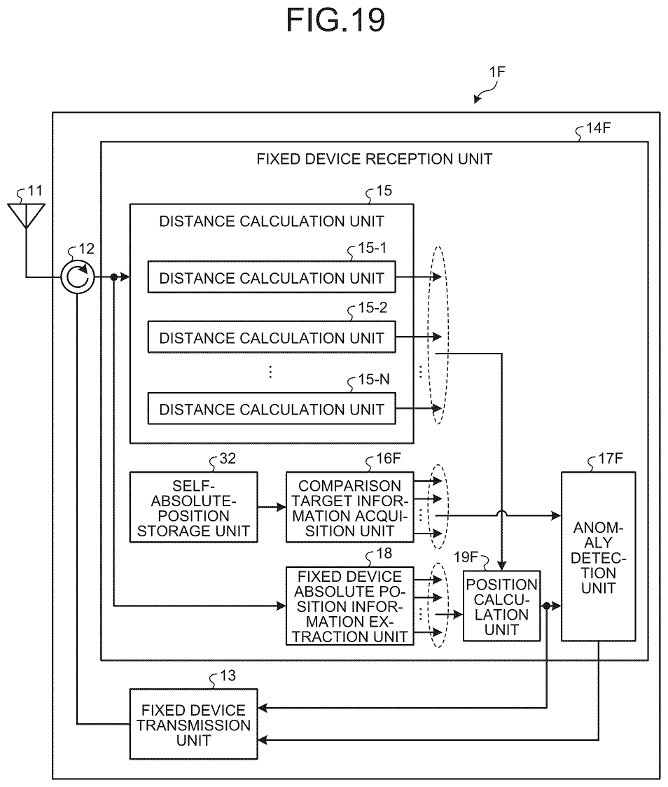

FIG. 19 is a diagram illustrating a functional configuration of a fixed device 1F according to a sixth embodiment. Hereinafter, a detailed description of functions similar to those of the fixed device 1D according to the fourth embodiment will be omitted, and differences from the fixed device 1D will be mainly described. Note that a system obtained by replacing the fixed device 1D of the wireless distance measuring system 100D according to the fourth embodiment with the fixed device 1F is referred to as the wireless distance measuring system 100F. The fixed device 1 includes the antenna 11, the circulator 12, the fixed device transmission unit 13, and a fixed device reception unit 14F. The fixed device reception unit 14F includes the distance calculation unit 15, a comparison target information acquisition unit 16F, an anomaly detection unit 17F, the fixed device absolute position information extraction unit 18, a position calculation unit 19F, and a self-absolute-position storage unit 32.

The self-absolute-position storage unit 32 is a storage device that stores the absolute position information of the target fixed device 1F itself. The self-absolute-position storage unit 32 can output the absolute position information of the target fixed device 1F itself to the comparison target information acquisition unit 16F.

The comparison target information acquisition unit 16F can acquire the absolute position information of the target fixed device 1F itself from the self-absolute-position storage unit 32, and output the acquired absolute position information to the anomaly detection unit 17F as comparison target information. In the sixth embodiment, the comparison target information is absolute position information indicating the scheduled position of the fixed device 1F.

The position calculation unit 19F calculates the position of the fixed device 1F itself with a method similar to that the position calculation unit 19 uses, and outputs the estimation result of the calculated position to the fixed device transmission unit 13 and the anomaly detection unit 17F.

The anomaly detection unit 17F can detect an anomaly occurring in the position of the target fixed device 1F based on whether the distance calculated by the distance calculation unit 15 matches the comparison target information acquired by the comparison target information acquisition unit 16F. Here, when the estimation result of the position calculated based on the calculation by the distance calculation unit 15 matches the absolute position information as the comparison target information, the anomaly detection unit 17F can determine that the distance calculated by the distance calculation unit 15 matches the comparison target information acquired by the comparison target information acquisition unit 16F. Specifically, the anomaly detection unit 17F compares the absolute position information with the position estimation result, and if the absolute position information and the position estimation result do not match, the anomaly detection unit 19 determines that an anomaly has occurred in any of the positions of the target fixed device 1F corresponding to the distance used by the position calculation unit 1F to calculate the position of the target fixed device 1F. For example, given that the target fixed device 1F is the fixed device 1F-1, the position calculation unit 19F estimates the position of the fixed device 1F-2 based on the distance between each of the fixed devices 1F-1 to 1F-4 and the fixed device 1F-1, and the estimation result of the position of the fixed device 1F-1 does not match the absolute position information of the fixed device 1F-1, the anomaly detection unit 17F can determine that an anomaly has occurred in any position of the fixed devices 1F-1 to 1F-4.

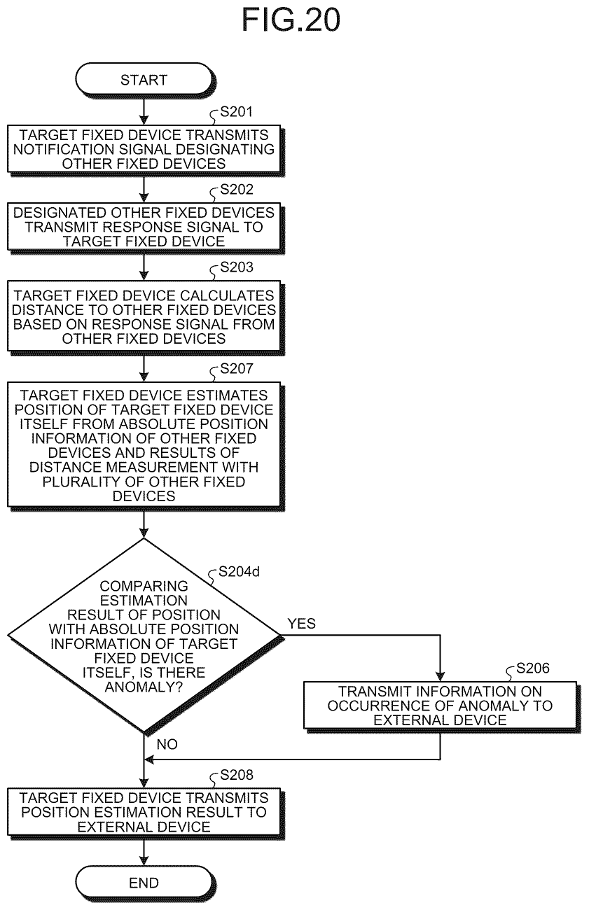

FIG. 20 is a flowchart for explaining the operation of the wireless distance measuring system 100F according to the sixth embodiment. Operations similar to those in the fourth embodiment are denoted by the same reference signs, and a detailed description thereof will be omitted. Differences from the fourth embodiment will be mainly described

Because steps S201 to S203 are similar to those in the fourth embodiment, and the description thereof is omitted here. After the processing in step S203 is completed, the target fixed device 1F estimates the position of the target fixed device 1F itself from the absolute position information of the other fixed devices 1F and the results of distance measurement with the plurality of other fixed devices 1F (step S207).

After the processing in step S207, the anomaly detection unit 17F of the target fixed device 1F compares the estimation result of the position with the absolute position information of the target fixed device 1F itself and determines whether there is an anomaly (step S204d). In response to determining that there is an anomaly (step S204d: Yes), the anomaly detection unit 17F of the target fixed device 1F transmits information on the occurrence of the anomaly to an external device such as a control server (step S206). In response to determining that there is no anomaly (step S204d: No), the target fixed device 1F transmits the estimation result of the position to an external device such as a control server (step S208).

As described above, the fixed device 1F according to the sixth embodiment can detect an anomaly in the position of the fixed device 1F based on the estimation result of the position of the fixed device 1F and the comparison target information that is the absolute position information of the fixed device 1F itself without using the inter-fixed-device distance information database 31 as in the fourth and fifth embodiments.

### Seventh Embodiment

The first to third embodiments above have described examples in which the mobile devices 2A, 2B, and 2C have the function of detecting an anomaly occurring in the position of the fixed device 1, and the fourth to sixth embodiments have described examples in which the fixed devices 1D, 1E, and 1F have the function of detecting an anomaly occurring in the position of the fixed devices 1D, 1E, and 1F. In a wireless distance measuring system 100G according to a seventh embodiment, both the fixed device 1 and the mobile device 2 have the anomaly detection function. The fixed device 1 included in the wireless distance measuring system 100G may be any of the fixed devices 1D, 1E, and 1F, and the mobile device 2 included in the wireless distance measuring system 100G may be any of the mobile devices 2A, 2B, and 2C. The wireless distance measuring system 100G measures the distance between the mobile device 2 and the fixed device 1 based on a wireless signal transmitted and received between the mobile device 2 and the fixed device 1, and measures the distance between different fixed devices 1 based on a wireless signal transmitted and received between different fixed devices 1.

In this case, the mobile devices 2A, 2B, and 2C according to the first to third embodiments perform wireless communication for distance measurement with the fixed device 1, and the fixed devices 1D, 1E, and 1F according to the fourth to sixth embodiments perform wireless communication for distance measurement with the other fixed devices 1D, 1E, and 1F. Therefore, it is necessary to take measures so that these communications do not interfere with each other. A possible example of a measure is to perform communication between the fixed device 1 and the mobile device 2 and communication between different fixed devices 1 in a time division manner by separately defining the operation periods of time therefor. For example, because the communication between the fixed device 1 and the mobile device 2 is limited to the periods of time in which the mobile device 2 travels under the control of the target fixed device 1, the fixed device 1 grasps in advance the periods of time in which the mobile device 2 travels under its control, the mobile device 2 performs the anomaly detection process of the position of the fixed device 1 using the estimation result of the distance to the fixed device 1 as described in the first to third embodiments in the periods of time, and the fixed device 1 performs the anomaly detection process of the position of the fixed device 1 based on the estimation result of the distance to other fixed devices 1 as described in the fourth to sixth embodiments in the periods of time in which the mobile device 2 does not travel under the control of the target fixed device 1. In this way, the periods of time in which the communication between the fixed device 1 and the mobile device 2 is performed and the periods of time in which the communication between the fixed devices 1 is performed are defined separately in a time division manner, whereby it is possible to avoid interference between these communications. Note that, even in the periods of time in which the mobile device 2 travels under the control of the target fixed device 1, communication between the fixed device 1 and the mobile device 2 and communication between different fixed devices 1 can coexist by finely dividing time slots and appropriately allocating communication periods of time.

In addition, a method of allocating different frequency channels to communication between the fixed device 1 and the mobile device 2 and communication between different fixed devices 1 may be used. Alternatively, a method of allocating different spreading codes to communication between the fixed device 1 and the mobile device 2 and communication between different fixed devices 1 and performing code multiplexing at the same time and the same frequency is also possible.

As described above, in the wireless distance measuring system 100G according to the seventh embodiment, both the fixed device 1 and the mobile device 2 have the function of performing the anomaly detection process of detecting an anomaly occurring in the position of the fixed device 1. As a result, the anomaly related to the position of the fixed device 1 can be detected more densely in terms of time, which brings about the effect of making it possible to improve the accuracy of the anomaly detection process of the position of the fixed device 1.

Next, hardware configurations for implementing the functions of the fixed device 1 and the mobile device 20 will be described. The functions of the fixed device 1 and the mobile device 2 are implemented by processing circuitry. The processing circuitry may be implemented by dedicated hardware or may be a control circuit using a central processing unit (CPU).

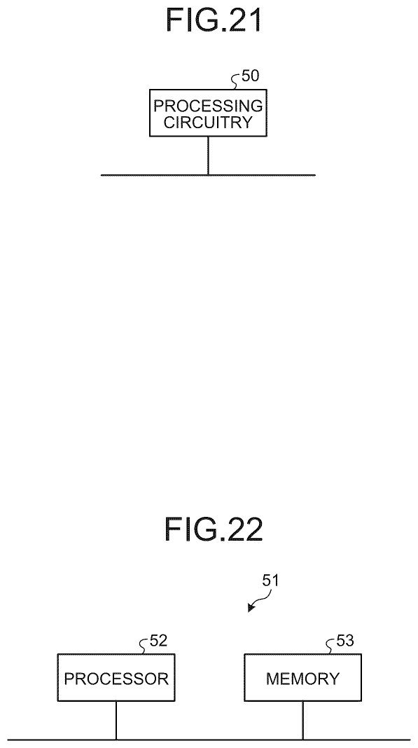

In a case where the above processing circuitry is implemented by dedicated hardware, the processing circuitry is implemented by processing circuitry 50 illustrated in FIG. 21. FIG. 21 is a diagram illustrating dedicated hardware for implementing the functions of the fixed device 1 and the mobile device 2 according to the first to seventh embodiments. The processing circuitry 50 is a single circuit, a composite circuit, a programmed processor, a parallel programmed processor, an application specific integrated circuit (ASIC), a field programmable gate array (FPGA), or a combination thereof.

In a case where the above processing circuitry is implemented by a control circuit using a CPU, this control circuit is, for example, a control circuit 51 having the configuration illustrated in FIG. 22. FIG. 22 is a diagram illustrating a configuration of the control circuit 51 for implementing the functions of the fixed device 1 and the mobile device 2 according to the first to seventh embodiments. As illustrated in FIG. 22, the control circuit 51 includes a processor 52 and a memory 53. The processor 52 is a CPU, and is also called an arithmetic device, a microprocessor, a microcomputer, a digital signal processor (DSP), or the like. Examples of the memory 93 include a non-volatile or volatile semiconductor memory, a magnetic disk, a flexible disk, an optical disc, a compact disc, a mini disc, a digital versatile disk (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In a case where the above processing circuitry is implemented by the control circuit 51, the processor 52 reads and executes the program corresponding to the process of each component stored in the memory 53, thereby implementing the processing circuitry. The memory 53 is also used as a temporary memory for each process executed by the processor 52. Note that the program that is executed by the processor 52 may be provided by being stored in a storage medium, or may be provided via a communication path.

In addition, the functions of the fixed device 1 and the mobile device 2 may be implemented by combining the processing circuitry 50 illustrated in FIG. 21 and the control circuit 51 illustrated in FIG. 22. In this case, how to divide the functional units of the fixed device 1 and the mobile device 2 is not limited to the illustrated examples, and the function of one functional unit illustrated may be implemented by a plurality of circuits, or the functions of a plurality of functional units illustrated may be implemented by one circuit.

Note that the fixed device 1 and the mobile device 2 are not dedicated terminals for anomaly detection, but are used, for example, for movement management of the mobile device 2 in addition to anomaly detection. For example, the estimation result of the distance between the fixed device 1 and the mobile device 2 is used for operation management of mobile objects equipped with the mobile device 2 in addition to the anomaly detection process.

The configurations described in the above-mentioned embodiments indicate examples. The embodiments can be combined with another well-known technique and with each other, and some of the configurations can be omitted or changed in a range not departing from the gist.

For example, in the above embodiment, the mobile device 2 is mounted on a train, and the fixed device 1 is installed along a track, but the technique of the present disclosure is not limited to this example. The mobile device 2 that has the anomaly detection function can be applied to any system as long as the distance between the fixed device 1 and the mobile device 2 is known in advance. The mobile device 2 may be mounted on mobile objects that move along a predetermined route, such as buses, satellites, or airplanes. In addition, vehicles can also be applied as mobile objects equipped with the mobile device 2 when, for example, traveling on an expressway or traveling on a predetermined route. In addition, the mobile device 2 may be mounted on robots that go around a set route. A predetermined route may be not only a route that is not basically changed, such as a route on which a train travels on a track in a determined order, but also a route that is changed for each ride, such as a route that is determined before the start of traveling by setting a destination in a self-driving vehicle.

The communication device according to the present disclosure can achieve the effect of making it possible to detect an anomaly occurring in the position of the device even in a place where GPS positioning cannot be performed.

What is claimed is:

1. A communication device that wirelessly communicates with a fixed device fixed on a ground, the communication device comprising:
distance calculation circuitry to calculate a distance between the fixed device and the communication device based on a reception signal from the fixed device;
comparison target information acquisition circuitry to acquire comparison target information that is information indicating a distance between the fixed device and the communication device or an absolute position of the communication device, the information being based on a scheduled position of the communication device; and
anomaly detection circuitry to detect an anomaly occurring in the position of the fixed device based on whether the distance calculated by the distance calculation circuitry matches the comparison target information.

2. The communication device according to claim 1, wherein
the communication device further includes a database including the comparison target information, and
the comparison target information acquisition circuitry acquires the comparison target information from the database included in the communication device.

3. The communication device according to claim 1, wherein
the comparison target information is stored outside the communication device, and
the comparison target information acquisition circuitry extracts the comparison target information from a reception signal.

4. The communication device according to claim 1, wherein
the communication device is a mobile device an absolute position of which changes,
the comparison target information is distance information indicating a distance that changes with time as the mobile device moves between the fixed device and the mobile device, and
the anomaly detection circuitry detects the anomaly based on whether the distance calculated by the distance calculation circuitry matches the distance information.

5. The communication device according to claim 4, wherein the mobile device moves along a predetermined route.

6. The communication device according to claim 1, wherein
the communication device is a fixed device fixed on a ground, and
the comparison target information is distance information indicating a distance between another fixed device and the communication device.

7. The communication device according to claim 1, wherein
the communication device is a fixed device fixed on a ground, and
the communication device further includes position calculation circuitry to calculate a position of the communication device using the distance calculated by the distance calculation circuitry,
the comparison target information indicates an absolute position of the communication device, and
the anomaly detection circuitry detects the anomaly based on whether the calculated position matches the absolute position.

8. The communication device according to claim 1, wherein the distance calculation circuitry calculates a distance between the fixed device and the communication device based on the reception signal that is an ultra-wide band signal.

9. A wireless distance measuring system comprising:
a mobile device that is the communication device according to claim 4; and
a plurality of the fixed devices fixed on the ground, wherein
a distance between the mobile device and the fixed devices is measured based on a wireless signal transmitted and received between the mobile device and the fixed devices.

10. A wireless distance measuring system comprising
a fixed device that is the communication device according to claim 6, wherein
a distance between different fixed devices is measured based on a wireless signal transmitted and received between the different fixed devices.

11. A wireless distance measuring system comprising
a fixed device that is the communication device according to claim 7, wherein
a distance between different fixed devices is measured based on a wireless signal transmitted and received between the different fixed devices.

12. A wireless distance measuring system comprising:
a mobile device that is the communication device according to claim 1, wherein an absolute position of the mobile device changes, the comparison target information is distance information indicating a distance that changes with time as the mobile device moves between the fixed device and the mobile device, and the anomaly detection circuitry detects the anomaly based on whether the distance calculated by the distance calculation circuitry matches the distance information; and
a plurality of fixed devices including at least one communication device according to claim 1, wherein the communication device is a fixed device fixed on a ground, and the comparison target information is distance information indicating a distance between another fixed device and the communication device, wherein
a distance between the mobile device and the fixed devices is measured based on a wireless signal transmitted and received between the mobile device and the fixed devices, and a distance between different fixed devices is measured based on a wireless signal transmitted and received between the different fixed devices.

13. The wireless distance measuring system according to claim 12, wherein the mobile device moves along a predetermined route.

14. A wireless distance measuring system comprising:
a mobile device that is the communication device according to claim 1, wherein an absolute position of the mobile device changes, the comparison target information is distance information indicating a distance that changes with time as the mobile device moves between the fixed device and the mobile device, and the anomaly detection circuitry detects the anomaly based on whether the distance calculated by the distance calculation circuitry matches the distance information; and
a plurality of fixed devices including at least one communication device according to claim 1, wherein the communication device is a fixed device fixed on a ground, the communication device further includes position calculation circuitry to calculate a position of the communication device using the distance calculated by the distance calculation circuitry, the comparison target information indicates an absolute position of the communication device, and the anomaly detection circuitry detects the anomaly based on whether the calculated position matches the absolute position, wherein
a distance between the mobile device and the fixed devices is measured based on a wireless signal transmitted and received between the mobile device and the fixed devices, and a distance between different fixed devices is measured based on a wireless signal transmitted and received between the different fixed devices.

15. The wireless distance measuring system according to claim 14, wherein the mobile device moves along a predetermined route.

16. The wireless distance measuring system according to claim 12, wherein communication between the mobile device and the fixed devices and communication between the different fixed devices are performed in a time division manner.

17. The wireless distance measuring system according to claim 13, wherein communication between the mobile device and the fixed devices and communication between the different fixed devices are performed in a time division manner.

18. The wireless distance measuring system according to claim 14, wherein communication between the mobile device and the fixed devices and communication between the different fixed devices are performed in a time division manner.

19. The wireless distance measuring system according to claim 15, wherein communication between the mobile device and the fixed devices and communication between the different fixed devices are performed in a time division manner.

20. The wireless distance measuring system according to claim 12, wherein different frequency channels are allocated to communication between the mobile device and the fixed devices and communication between the different fixed devices.

21. The wireless distance measuring system according to claim 13, wherein different frequency channels are allocated to communication between the mobile device and the fixed devices and communication between the different fixed devices.

22. The wireless distance measuring system according to claim 14, wherein different frequency channels are allocated to communication between the mobile device and the fixed devices and communication between the different fixed devices.

23. The wireless distance measuring system according to claim 15, wherein different frequency channels are allocated to communication between the mobile device and the fixed devices and communication between the different fixed devices.

24. The wireless distance measuring system according to claim 12, wherein code multiplexing is performed by allocating different spreading codes to communication between the mobile device and the fixed devices and communication between the different fixed devices.

25. The wireless distance measuring system according to claim 13, wherein code multiplexing is performed by allocating different spreading codes to communication between the mobile device and the fixed devices and communication between the different fixed devices.

26. The wireless distance measuring system according to claim 14, wherein code multiplexing is performed by allocating different spreading codes to communication between the mobile device and the fixed devices and communication between the different fixed devices.

27. The wireless distance measuring system according to claim 15, wherein code multiplexing is performed by allocating different spreading codes to communication between the mobile device and the fixed devices and communication between the different fixed devices.

28. A control circuit that controls a communication device that wirelessly communicates with a fixed device fixed on a ground, the control circuit causing the communication device to execute:
calculating a distance between the fixed device and the communication device based on a transmission signal from the fixed device;
acquiring comparison target information that is information indicating a distance between the fixed device and the communication device or an absolute position of the communication device, the information being based on a scheduled position of the communication device; and
detecting an anomaly occurring in the position of the fixed device based on whether the distance calculated matches the comparison target information.

29. A non-transitory storage medium storing a program for controlling a communication device that wirelessly communicates with a fixed device fixed on a ground, the program causing the communication device to execute:
calculating a distance between the fixed device and the communication device based on a transmission signal from the fixed device;
acquiring comparison target information that is information indicating a distance between the fixed device and the communication device or an absolute position of the communication device, the information being based on a scheduled position of the communication device; and
detecting an anomaly occurring in the position of the fixed device based on whether the distance calculated matches the comparison target information.

30. An anomaly detection method that is executed by a communication device that wirelessly communicates with a fixed device fixed on a ground, the anomaly detection method comprising:
calculating a distance between the fixed device and the communication device based on a transmission signal from the fixed device;
acquiring comparison target information that is information indicating a distance between the fixed device and the communication device or an absolute position of the communication device, the information being based on a scheduled position of the communication device; and
detecting an anomaly occurring in the position of the fixed device based on whether the distance calculated matches the comparison target information.
